(19) United States
(12) Patent Application Publication
(10) Pub. No.: US 2025/0317076 A1
(43) Pub. Date: Oct. 9, 2025

(54) HETEROGENEOUS GRAPHENE OXIDE WET GENERATOR AND PREPARATION METHOD

(71) Applicants: Kunming University of Science and Technology, Kunming (CN); Guangdong Morion Nanotech Co., Ltd., Dongguan (CN)

(72) Inventors: Jinming CAI, Kunming (CN); Xiaoming CAI, Kunming (CN); Yu GAO, Kunming (CN)

(73) Assignees: Kunming University of Science and Technology, Kunming (CN); Guangdong Morion Nanotech Co., Ltd., Dongguan (CN)

(21) Appl. No.: 19/172,680

(22) Filed: Apr. 8, 2025

Related U.S. Application Data
(63) Continuation of application No. PCT/CN2025/072458, filed on Jan. 15, 2025.

(30) Foreign Application Priority Data
Apr. 7, 2024 (CN) 202410409587.5

(51) Int. Cl. H02N 3/00; C01B 32/194; C01B 32/198; F03G 7/00

(52) U.S. Cl. CPC H02N 3/00; C01B 32/194; C01B 32/198; F03G 7/008; C01B 2204/22; C01P 2002/72; C01P 2006/40

(57) ABSTRACT

A heterogeneous graphene oxide wet generator and a preparation method are provided. A heterogeneous graphene oxide wet generator includes an integrated forming heterostructure composed of the first part and the second part arranged in the left-right position or the up-down position, the material of the first part is graphene oxide, and the material of the second part is reduced graphene oxide. The heterogeneous graphene oxide wet generator provided by the invention has high open circuit voltage, excellent cycle stability, and has the potential to be applied to flexible batteries, after a series-parallel connection, a generator set with a high voltage can be obtained, and a reduction device can be installed on the industrial coating line for preparing graphene oxide, which is expected to be mass-produced.

### CROSS REFERENCE TO THE RELATED APPLICATIONS

This application is a continuation application of International Application No. PCT/CN2025/072458, filed on Jan. 15, 2025, which is based upon and claims priority to Chinese Patent Application No. 202410409587.5, filed on Apr. 7, 2024, the entire contents of which are incorporated herein by reference.

### TECHNICAL FIELD

The embodiment of the invention relates to the field of wet power generation technology, in particular to a heterogeneous graphene oxide wet generator and a preparation method.

### BACKGROUND

Recent studies have shown that the interaction between two-dimensional materials represented by graphene and water molecules can produce the phenomenon of charge transfer transmission due to the quantum confinement effect and the environmentally sensitive surface effect caused by large specific surface area, so it is expected to collect energy from water cycles such as rainwater, waves, flow, and natural evaporation, that is, the wet power generation effect. Two-dimensional materials have large in-plane electron mobility, good thermal conductivity, high mechanical strength, and toughness, and can be used to prepare flexible devices, they have many advantages such as green environmental protection, wide sources, simple structure, safety and non-toxicity, and low cost, it is expected to construct new flexible power generation and energy storage devices for the use of micro and flexible devices, the implementation of this project and the promotion of related achievements are expected to enrich the types of new energy industries, cultivate new kinetic energy for economic development, and promote the development of new energy industries, it is of great significance to alleviate the energy crisis and solve environmental pollution problems.

In the existing wet power generation technology, the output power of wet power generation performance is usually regulated by carbon black and different degrees of functionalization of graphite surface, there are also studies on wet power generation devices based on two-dimensional graphene materials, a weak current is produced by the movement of sodium chloride solution on the surface of two-dimensional graphene sheet. The magnitude and direction of the induced current can be controlled by adjusting the moving speed and direction of the solution and the molar amount of sodium chloride in the solution. However, the current power density of wet power generation technology is too low, which depends heavily on the directional movement of water molecules on the surface of functionalized two-dimensional materials, or requires a large gradient of humidity environment, the generated power is a pulse-type voltage signal, which cannot continuously and stably improve high-power electricity, nor can it be packaged or prepared on a large scale.

### SUMMARY

Therefore, the embodiment of the invention provides a heterogeneous graphene oxide wet generator and a preparation method.

In order to achieve the above purpose, the embodiment of the invention provides the following technical scheme:

According to the first aspect of the embodiment of the invention, the invention provides a heterogeneous graphene oxide wet generator, including an integrated forming heterostructure composed of a first part and a second part arranged in a left-right position or an up-down position, a material of the first part is graphene oxide, and a material of the second part is reduced graphene oxide.

Furthermore, the integrated forming heterostructure is a planar membrane structure or a three-dimensional structure.

Furthermore, the graphene oxide is prepared by a chemical oxidation method using graphite as a raw material.

The preparation of graphene oxide by chemical oxidation is a conventional method in this field. As an example, the flake graphite, potassium permanganate, and concentrated sulfuric acid are mixed and stirred at a ratio of 1 g:4 g:25 mL by the modified Hummers method for low-temperature reaction (0° C., 30 min), medium-temperature reaction (40° C., 3 h), and deionized water is added for high-temperature reaction (95° C., 5 min), after the high-temperature reaction, hydrogen peroxide is added to peel off the graphene oxide sheet to obtain a yellow graphene oxide solution, and the graphene oxide slurry was obtained after repeated cleaning and centrifugation.

Furthermore, the reduced graphene oxide is prepared by thermal reduction, chemical reduction, or laser reduction using graphene oxide as raw material.

The preparation of reduced graphene oxide by reduction method is a conventional method in this field. As an example, thermal reduction: Graphene oxide is exposed to air or a reducing atmosphere through high-temperature heat treatment to remove oxygen groups and thus reduce to graphene. For example, heat treatment or thermal decomposition is used in an inert atmosphere. The reduction temperature is 200-1200° C. and the reduction time is 10 s-60 min. Chemical reduction: Graphene oxide is reduced to graphene using a chemical reducing agent. The commonly used chemical reducing agents include hydrogen, hydrogen iodide, hydrazine hydrate, etc. These reducing agents can react with oxygen atoms and remove them to reduce graphene. Temperature range: 20-100° C., reaction time: 1 min-24 h. Laser reduction: Laser radiation is used to heat the graphene oxide locally to cause a reduction reaction. Laser power: 10 W-30 W, laser wavelength: 532 nm or 1064 nm, laser irradiation time: 1 s-1 min.

According to the second aspect of the embodiment of the invention, the invention provides a preparation method for the heterogeneous graphene oxide wet generator as described above, the method includes the following steps:
(1) preparing a flake graphite into a graphene oxide slurry by chemical oxidation;
(2) coating the graphene oxide slurry in batches, and obtaining a graphene oxide film after drying and rolling;
(3) reducing a part of the graphene oxide film to obtain a heterogeneous graphene oxide film;
(4) cutting the heterogeneous graphene oxide film into a specific size, and connecting two sides the heterogeneous graphene oxide film with a wire;
(5) humidifying the graphene oxide film, and then encapsulating the wire, heterogeneous graphene oxide film, and water together to obtain a heterogeneous graphene oxide wet generator.

Furthermore, the method also includes collecting the heterogeneous graphene oxide wet generators in series or parallel to obtain an integrated power generation array.

The embodiment of the invention has the following advantages:
(1) A heterogeneous graphene oxide wet generator prepared by the invention, due to the heterogeneous gradient structure formed, the contact area between water molecules and oxygen-containing groups increases, and an open circuit voltage of 0.96 V can be generated.
(2) A heterogeneous graphene oxide wet generator prepared by the invention has a power density of 879.2 μWcm⁻³, which can operate stably for more than 24 h for a long time, and can be restored after humidification, it has excellent cycle stability.
(3) A heterogeneous graphene oxide wet generator prepared by the invention can be bent after flexible packaging. After bending 180°, its output performance is not affected, and it has the potential to be applied to flexible batteries.
(4) A heterogeneous graphene oxide wet generator prepared by the invention can obtain a generator set with a large voltage after a series-parallel connection, a reduction device can be added to the industrial coating line for preparing graphene oxide, which is expected to be produced in batches in a large scale.

### BRIEF DESCRIPTION OF THE DRAWINGS

In order to more clearly explain the embodiment of the invention or the technical scheme in the existing technology, the following will briefly introduce the drawings that need to be used in the description of the embodiment, or the existing technology. Obviously, the drawings in the following description are only illustrative. For ordinary technicians in this field, other drawings can be obtained according to the extension of the provided drawings without paying creative labor.

FIG. 1 is the schematic diagram of the heterogeneous graphene oxide wet generator provided by the invention, where 1 is water molecule, 2 is graphene oxide, 3 is reduced graphene oxide, 4 is wire, and 5 is LED light.

FIG. 2 is a picture of the coating process of graphene oxide film provided by the invention.

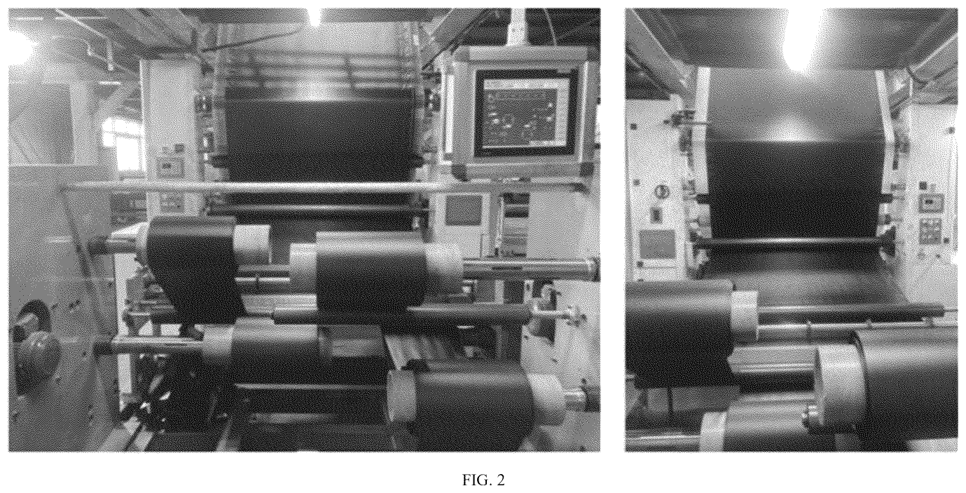

FIGS. 3A-3B show the coating line diagram (FIG. 3A) of the batch preparation of heterogeneous graphene oxide and the schematic diagram (FIG. 3B) of cutting heterogeneous graphene oxide provided by the invention.

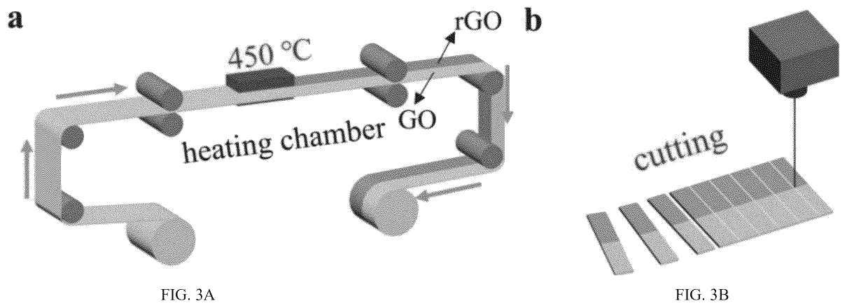

FIG. 4 is an XRD diagram of the heterogeneous graphene oxide wet generator provided by the invention, GO is graphene oxide and rGO is reduced graphene oxide.

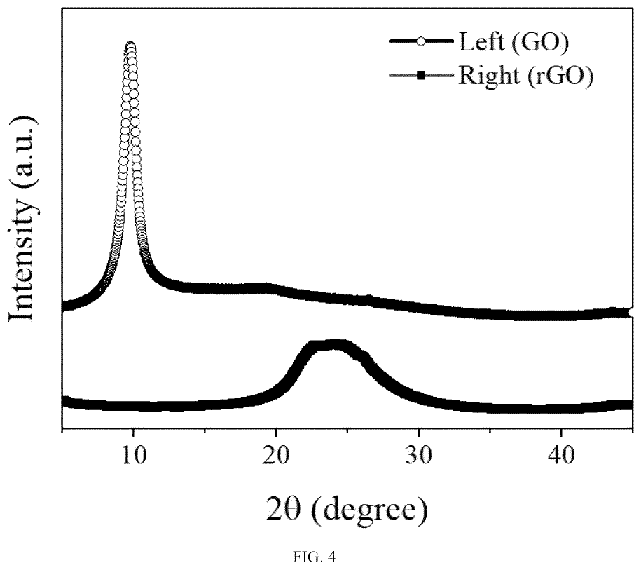

FIG. 5 shows the open circuit voltage test data of the heterogeneous graphene oxide wet generator provided by the invention, which has a stable open circuit voltage of 0.96 V.

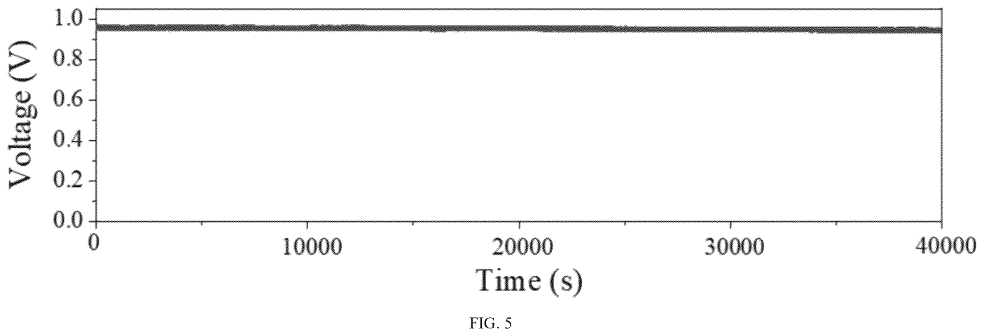

FIG. 6 is a voltage diagram of 15 V obtained by a series connection of the heterogeneous graphene oxide wet generators provided by the invention.

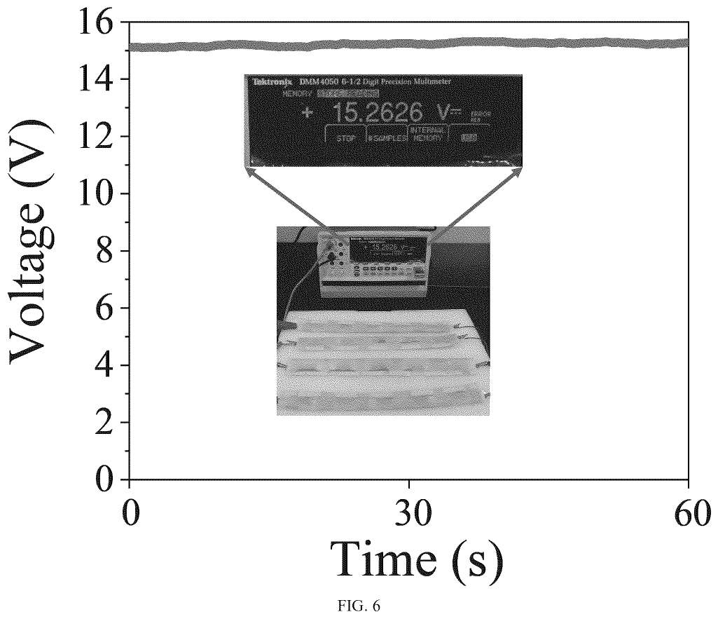

FIG. 7 is a bending test diagram of the heterogeneous graphene oxide wet generator provided by the invention, which remains stable under different bending degrees.

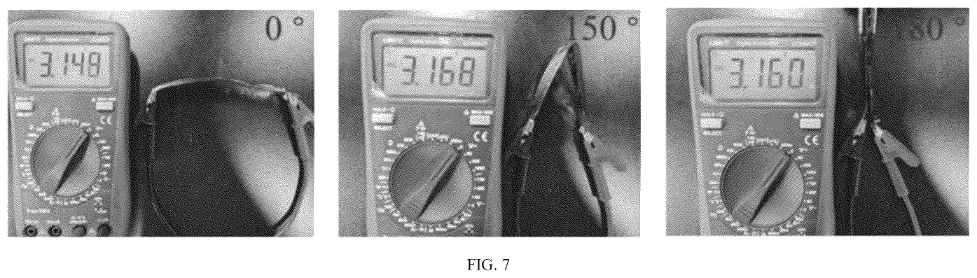

FIG. 8 is a picture of the heterogeneous graphene oxide wet generator provided by the invention powering an electronic watch.

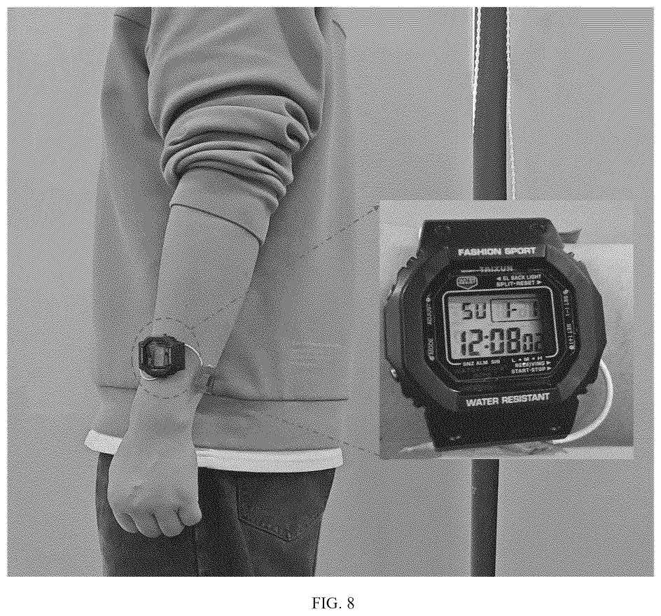

### DETAILED DESCRIPTION OF THE EMBODIMENTS

The following specific embodiments illustrate the embodiment of the invention, people familiar with this technology can easily understand the other advantages and efficacy of the invention from the contents disclosed in this specification, obviously, the embodiments described are a part of the embodiments of the invention, not all of the embodiments. Based on the embodiments in this invention, all other embodiments obtained by ordinary technicians in this field without making creative labor belong to the scope of protection of this invention.

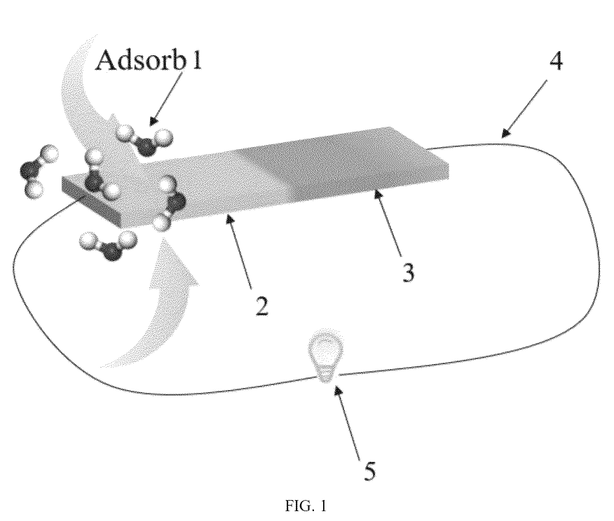

As shown in FIG. 1, the invention provides a heterogeneous graphene oxide wet generator, including the water molecule 1, the graphene oxide 2, the reduced graphene oxide 3, the wire 4, the LED light 5, where the graphene oxide 2 and the reduced graphene oxide 3 are integrated structures, and there is no fracture in the plane.

### Example 1

This embodiment provides a preparation method for a heterogeneous graphene oxide wet generator, including the following steps:
(1) Graphene oxide slurry was prepared by chemical oxidation of flake graphite

Specifically: The flake graphite, potassium permanganate, and concentrated sulfuric acid were mixed and stirred at a ratio of 1 g:4 g:25 mL by the modified Hummers method for low-temperature reaction (0° C., 30 min), medium-temperature reaction (40° C., 3 h), and deionized water was added for high-temperature reaction (95° C., 5 min), after the high-temperature reaction, hydrogen peroxide was added to peel off the graphene oxide sheet to obtain a yellow graphene oxide solution, and the graphene oxide slurry was obtained after repeated cleaning and centrifugation;
(2) The graphene oxide slurry was coated in batches, and the graphene oxide film was obtained after drying and rolling

Specifically: the solid content and viscosity of the graphene oxide slurry were adjusted, and the graphene oxide film (200 μm thick) was obtained after coating and drying on the coating production line;
(3) A part of the graphene oxide film was reduced to obtain the reduced graphene oxide

Specifically: the right part of the graphene oxide film was reduced by thermal reduction, in the atmospheric atmosphere, the reduction temperature was set to 450° and the thermal reduction time was set to 60 s to obtain the reduced graphene oxide;
(4) The heterogeneous graphene oxide film was cut into a size of 1*3 cm, where the length and width of the graphene oxide in the heterogeneous graphene oxide film were 1*1.5 cm, and the length and width of the reduced graphene oxide were 1*1.5 cm, the copper wire was connected to both sides of the heterogeneous graphene oxide film with a conductive silver paste and dried in a drying oven at 60° C. for 1 h;
(5) The graphene oxide film was humidified, and then the wires connected to the film, heterogeneous graphene oxide film, and water were encapsulated together to obtain a heterogeneous graphene oxide wet generator

Specifically: The left part of the graphene oxide film was dripped into 200 μL of deionized water, and the entire heterogeneous graphene oxide film and wire were encapsulated with a PI film to obtain a heterogeneous graphene oxide wet generator;
(6) The heterogeneous graphene oxide wet generator was connected in series/parallel to obtain an integrated power generation array.

### Example 2

This embodiment provides a preparation method for a heterogeneous graphene oxide wet generator, including the following steps:
(1) Graphene oxide slurry was prepared by chemical oxidation of flake graphite

Specifically: The flake graphite, potassium permanganate, and concentrated sulfuric acid were mixed and stirred at a ratio of 1 g:4 g:25 mL by the modified Hummers method for low-temperature reaction (0° C., 30 min), medium-temperature reaction (40° C., 3 h), and deionized water was added for high-temperature reaction (95° C., 5 min), after the high-temperature reaction, hydrogen peroxide was added to peel off the graphene oxide sheet to obtain a yellow graphene oxide solution, and the graphene oxide slurry was obtained after repeated cleaning and centrifugation;
(2) The graphene oxide slurry was coated in batches, and the graphene oxide film was obtained after drying and rolling

Specifically: the solid content and viscosity of the graphene oxide slurry were adjusted, and the graphene oxide film (200 μm thick) was obtained after coating and drying on the coating production line;
(3) A part of the graphene oxide film was reduced to obtain the reduced graphene oxide

Specifically: the right part of the graphene oxide film was reduced by thermal reduction, in the atmospheric atmosphere, the reduction temperature was set to 450° and the thermal reduction time was set to 100 s to obtain the reduced graphene oxide;
(4) The heterogeneous graphene oxide film was cut into a size of 0.5*1 cm, where the length and width of the graphene oxide in the heterogeneous graphene oxide film were 0.5*0.5 cm, and the length and width of the reduced graphene oxide were 0.5*0.5 cm, the copper wire was connected to both sides of the heterogeneous graphene oxide film with a conductive silver paste and dried in a drying oven at 60° C. for 1 h;
(5) The graphene oxide film was humidified, and then the wires connected to the film, heterogeneous graphene oxide film, and water were encapsulated together to obtain a heterogeneous graphene oxide wet generator

Specifically: The left part of the graphene oxide film was dripped into 200 μL of deionized water, and the entire heterogeneous graphene oxide film and wire were encapsulated with a PI film to obtain a heterogeneous graphene oxide wet generator;
(6) The heterogeneous graphene oxide wet generator was connected in series/parallel to obtain an integrated power generation array.

### Example 3

This embodiment provides a preparation method for a heterogeneous graphene oxide wet generator, including the following steps:
(1) Graphene oxide slurry was prepared by chemical oxidation of flake graphite

Specifically: The flake graphite, potassium permanganate, and concentrated sulfuric acid were mixed and stirred at a ratio of 1 g:4 g:25 mL by the modified Hummers method for low-temperature reaction (0° C., 30 min), medium-temperature reaction (40° C., 3 h), and deionized water was added for high-temperature reaction (95° C., 5 min), after the high-temperature reaction, hydrogen peroxide was added to peel off the graphene oxide sheet to obtain a yellow graphene oxide solution, and the graphene oxide slurry was obtained after repeated cleaning and centrifugation;
(2) The graphene oxide slurry was coated in batches, and the graphene oxide film was obtained after drying and rolling

Specifically: the solid content and viscosity of the graphene oxide slurry were adjusted, and the graphene oxide film (400 μm thick) was obtained after coating and drying on the coating production line;
(3) A part of the graphene oxide film was reduced to obtain the reduced graphene oxide

Specifically: the right part of the graphene oxide film was reduced by thermal reduction, in the atmospheric atmosphere, the reduction temperature was set to 450° and the thermal reduction time was set to 60 s to obtain the reduced graphene oxide;
(4) The heterogeneous graphene oxide film was cut into a size of 2*6 cm, where the length and width of the graphene oxide in the heterogeneous graphene oxide film were 2*3 cm, and the length and width of the reduced graphene oxide were 2*3 cm, the copper wire was connected to both sides of the heterogeneous graphene oxide film with a conductive silver paste and dried in a drying oven at 60° C. for 1 h;
(5) The graphene oxide film was humidified, and then the wires connected to the film, heterogeneous graphene oxide film, and water were encapsulated together to obtain a heterogeneous graphene oxide wet generator

Specifically: The left part of the graphene oxide film was dripped into 200 μL of deionized water, and the entire heterogeneous graphene oxide film and wire were encapsulated with a PI film to obtain a heterogeneous graphene oxide wet generator;
(6) The heterogeneous graphene oxide wet generator was connected in series/parallel to obtain an integrated power generation array.

### Example 4

This embodiment provides a preparation method for a heterogeneous graphene oxide wet generator, including the following steps:
(1) Graphene oxide slurry was prepared by chemical oxidation of flake graphite

Specifically: The flake graphite, potassium permanganate, and concentrated sulfuric acid were mixed and stirred at a ratio of 1 g:4 g:25 mL by the modified Hummers method for low-temperature reaction (0° C., 30 min), medium-temperature reaction (40° C., 3 h), and deionized water was added for high-temperature reaction (95° C., 5 min), after the high-temperature reaction, hydrogen peroxide was added to peel off the graphene oxide sheet to obtain a yellow graphene oxide solution, and the graphene oxide slurry was obtained after repeated cleaning and centrifugation;
(2) The graphene oxide slurry was coated in batches, and the graphene oxide film was obtained after drying and rolling

Specifically: the solid content and viscosity of the graphene oxide slurry were adjusted, and the graphene oxide film (400 μm thick) was obtained after coating and drying on the coating production line;
(3) A part of the graphene oxide film was reduced to obtain the reduced graphene oxide

Specifically: the right part of the graphene oxide film is reduced by laser reduction, the laser switch is turned on, the current is set to 2.5 A, the output power is 25 W, the laser moves on the graphene oxide film, and the reduced graphene oxide is obtained within 1 s;
(4) The heterogeneous graphene oxide film was cut into a size of 1*3 cm, where the length and width of the graphene oxide in the heterogeneous graphene oxide film were 1*1.5 cm, and the length and width of the reduced graphene oxide were 1*1.5 cm, the copper wire was connected to both sides of the heterogeneous graphene oxide film with a conductive silver paste and dried in a drying oven at 60° C. for 1 h;
(5) The graphene oxide film was humidified, and then the wires connected to the film, heterogeneous graphene oxide film, and water were encapsulated together to obtain a heterogeneous graphene oxide wet generator

Specifically: The left part of the graphene oxide film was dripped into 200 μL of deionized water, and the entire heterogeneous graphene oxide film and wire were encapsulated with a PI film to obtain a heterogeneous graphene oxide wet generator;
(6) The heterogeneous graphene oxide wet generator was connected in series/parallel to obtain an integrated power generation array.

### Example 5

This embodiment provides a preparation method for a heterogeneous graphene oxide wet generator, including the following steps:
(1) Graphene oxide slurry was prepared by chemical oxidation of flake graphite

Specifically: The flake graphite, potassium permanganate, and concentrated sulfuric acid were mixed and stirred at a ratio of 1 g:4 g:25 mL by the modified Hummers method for low-temperature reaction (0° C., 30 min), medium-temperature reaction (40° C., 3 h), and deionized water was added for high-temperature reaction (95° C., 5 min), after the high-temperature reaction, hydrogen peroxide was added to peel off the graphene oxide sheet to obtain a yellow graphene oxide solution, and the graphene oxide slurry was obtained after repeated cleaning and centrifugation;
(2) The graphene oxide slurry was coated in batches, and the graphene oxide film was obtained after drying and rolling

Specifically: the solid content and viscosity of the graphene oxide slurry were adjusted, and the graphene oxide film (800 μm thick) was obtained after coating and drying on the coating production line;
(3) A part of the graphene oxide film was reduced to obtain the reduced graphene oxide

Specifically: the right part of the graphene oxide film is reduced by laser reduction, the laser switch is turned on, the current is set to 2.5 A, the output power is 25 W, the laser moves on the graphene oxide film, and the reduced graphene oxide is obtained within 1 s;
(4) The heterogeneous graphene oxide film was cut into a size of 2*6 cm, where the length and width of the graphene oxide in the heterogeneous graphene oxide film were 2*3 cm, and the length and width of the reduced graphene oxide were 2*3 cm, the copper wire was connected to both sides of the heterogeneous graphene oxide film with a conductive silver paste and dried in a drying oven at 60° C. for 1 h;
(5) The graphene oxide film was humidified, and then the wires connected to the film, heterogeneous graphene oxide film, and water were encapsulated together to obtain a heterogeneous graphene oxide wet generator

Specifically: The left part of the graphene oxide film was dripped into 200 μL of deionized water, and the entire heterogeneous graphene oxide film and wire were encapsulated with a PI film to obtain a heterogeneous graphene oxide wet generator;
(6) The heterogeneous graphene oxide wet generator was connected in series/parallel to obtain an integrated power generation array.

### Examples of Testing

### 1. Chemical Composition Test XRD (X-Ray Diffraction)

Test method: The structural properties were determined by X-ray diffraction (XRD), and CuKα radiation (λ=0.15418 nm) was used at a scanning rate of 5°/min. The test results show that the characteristic peak at 10° is graphene oxide, and the characteristic peak at 24° is reduced graphene oxide, which proves that graphene oxide is transformed into reduced graphene oxide after reduction treatment.

### 2. Electricity Generation Test: Open Circuit Voltage Test

Test method: The wire of the heterogeneous graphene oxide wet power generation device (1*3 cm) encapsulated by the PI film in Step (5) of Example 1 was connected to the multi-function multimeter (DMM4050DigitPrecisionMultimeter) for testing. The ambient humidity is RH-75% and the ambient temperature is −25° C. The results show that the device can generate a stable open circuit voltage of 0.96 V.

### 3. Series Connection

Test method: The heterogeneous graphene oxide wet power generation device (1*3 cm) packaged by the PI film in Step (5) of Example 1 was connected in series with 16, and the connected battery pack was connected to the multi-function multimeter (DMM 4050Digit Precision Multimeter) for testing. The ambient humidity was RH-75% and the ambient temperature was −25° C. The results show that the device can obtain a high voltage of 15 V through a multi-stage series connection.

### 4. Bending Test

Test method: The heterogeneous graphene oxide wet power generation device (0.5*1 cm) packaged by the PI film in Step (5) of Example 2 was connected in series with 4, and the integrated power generation array was connected to the multimeter, and the bending test was performed by tweezers. The results show that under the bending of 0°, 30°, and 180°, the voltage does not change significantly and remains stable.

### 5. Electronic Watch Power Supply

Test method: The heterogeneous graphene oxide wet power generation device (1*3 cm) packaged by the PI film in Step (5) of Example 1 was connected in series to obtain five series of battery straps, the positive and negative electrodes are connected to the electronic watch to power the watch.

Although the invention has been described in detail with general instructions and specific embodiments above, on the basis of the invention, some modifications or improvements can be made, which is obvious to the technical personnel in this field. Therefore, these modifications or improvements made based on not deviating from the spirit of the invention belong to the scope of protection required by the invention.

What is claimed is:

1. A heterogeneous graphene oxide wet generator, comprising an integrated forming heterostructure, wherein the integrated forming heterostructure comprises a first part and a second part arranged in a left-right position or an up-down position, a material of the first part is graphene oxide, and a material of the second part is reduced graphene oxide.

2. The heterogeneous graphene oxide wet generator according to claim 1, wherein the integrated forming heterostructure is a planar membrane structure or a three-dimensional structure.

3. The heterogeneous graphene oxide wet generator according to claim 1, wherein the graphene oxide is prepared by a chemical oxidation method using graphite as a raw material.

4. The heterogeneous graphene oxide wet generator according to claim 1, wherein the reduced graphene oxide is prepared by a thermal reduction, a chemical reduction, or a laser reduction using the graphene oxide as a raw material.

5. A preparation method for the heterogeneous graphene oxide wet generator according to claim 1, comprising the following steps:
(1) preparing a flake graphite into a graphene oxide slurry by a chemical oxidation;
(2) coating the graphene oxide slurry in batches, and obtaining a graphene oxide film after drying and rolling;
(3) reducing a part of the graphene oxide film to obtain a heterogeneous graphene oxide film;
(4) cutting the heterogeneous graphene oxide film into a predetermined size, and connecting two sides of the heterogeneous graphene oxide film with a wire; and
(5) humidifying the graphene oxide film, and then encapsulating the wire, the heterogeneous graphene oxide film, and water together to obtain the heterogeneous graphene oxide wet generator.

6. The preparation method for the heterogeneous graphene oxide wet generator according to claim 5, further comprising collecting the heterogeneous graphene oxide wet generator in series or parallel to obtain an integrated power generation array.
